(19) United States
(12) Patent Application Publication
(10) Pub. No.: US 2009/0136006 A1
(43) Pub. Date: May 28, 2009

(54) AUTOMATIC EMERGENCY PROFILE

(76) Inventors: Stephen M. Milton, Freehold, NJ (US); William Joseph Toth, JR., Ocean, NJ (US)

Correspondence Address: MG-IP Law, PLLC, PO BOX 1364, FAIRFAX, VA, 22038-1364, US

(21) Appl. No.: 11/946,778

(22) Filed: Nov. 28, 2007

(51) Int. Cl. H04M 11/04

(52) U.S. Cl. 379/45; 455/404.1; 455/404.2; 379/37; 455/414.1

(57) ABSTRACT

A system and method are disclosed that automatically provide a user profile to an emergency call center. The system includes a network having a user profile manager configured to manage communication between a telecommunications device and the emergency call center, wherein the user profile manager is configured to automatically transmit the user profile to the emergency call center in response to a predetermined event.

### FIELD OF DISCLOSURE

The present invention relates to a system, apparatus, and method of automatically providing an emergency profile, and more particularly, to a system, apparatus, and method of automatically providing a user profile to an emergency call center.

### BACKGROUND

FIG. 1 depicts a schematic diagram of a conventional telecommunications system having an emergency call center. The telecommunications system 100 includes, for example:

i. telecommunications network 101,

ii. emergency call center 102,

iii. network telephone 103,

iv. private branch exchange 105,

v. on-premises telephones 106 and 107,

vi. Internet protocol network 108,

vii. Internet protocol telephone 109,

viii. cellular protocol network 110, and

ix. cellular telephones 112 and 113, each of which can be interconnected as shown.

The telecommunications network 101 is one of multiple, telecommunications networks that are represented in FIG. 1. The telecommunications network 101 includes a Public Switched Telephone Network, which is a complex of telecommunications equipment that is owned and operated by different entities throughout the World. In the United States of America, for example, the Public Switched Telephone Network (or “PSTN”) includes an address space that is defined by ten digits, and, therefore, comprises 10 billion unique addresses or “telephone numbers.” The public switched telephone networks in other countries are similar.

The network 101 interconnects the other telecommunications networks that include (i) the enterprise network supported by private branch exchange 105, (ii) Internet protocol network 108, and (iii) cellular protocol network 110. The enterprise network supported by the private branch exchange (PBX) 105 provides telecommunications service to one or more telecommunications terminals, for example, the telephones 106 and 107, within the enterprise area served, such as an office building or campus. The Internet protocol network 108 provides telecommunications service to one or more Internet protocol-capable telecommunications terminals, including the telephone 109. The cellular protocol network 110 provides telecommunications service to one or more cellular telecommunications terminals, including telephones 112 and 113.

Additionally, the network 101 provides telecommunications service to other telecommunications terminals, such as telephone 103. For example, the network 101 is able to route a call that telephone 103 originates to the PBX 105. The network 101 also provides telecommunications service to emergency call centers, such as emergency call center 102.

The Internet protocol network 108 is capable of switching incoming calls from network 101 to terminals that are capable of Voice over Internet Protocol (VoIP), such as telephone 109. The network 108 is also capable of handling outgoing calls from VoIP-capable terminals to the network 101. The network 108 handles calls that involve the telephone 109 via one or more routers.

The cellular protocol network 110 is capable of switching incoming calls from the network 101 to the cellular-capable terminals that have registered with the network, such as telephones 112 and 113. The network 110 is also capable of handling outgoing calls from the cellular-capable terminals to the network 101. The network 110 handles calls that involve telephones 112 and 113 via one or more mobile switching centers and radio base stations.

The PBX 105 is an enterprise system capable of switching incoming calls (e.g., originated by telephone 113, etc.) from the telecommunications network 101 via one or more communications paths to one or more on-premises terminals, such as on-premises telephones 106 and 107. The PBX 105 is also capable of handling outgoing calls from on-premises terminals to the network 101 via one or more communications paths.

In conventional emergency call systems, such as a 911 emergency call system, an emergency caller dials 911 on a telephone (e.g., telephone 103, 106, 107, 109, 112, 113, etc), which may be a wired or wireless telephone. The 911 call is received by a server at an emergency call center 102 and answered by a 911 dispatcher (i.e., operator, agent, etc.).

In some conventional systems, a location of the telephone can be determined at the time when the emergency caller dialed an emergency number, such as 911. For example, a telephone (e.g., telephone 112, 113, etc.) being used by the emergency caller may include a global positioning system (GPS) system such that a location of the telephone can be determined at the time when the emergency caller dialed 911. The location data can be transmitted by the telephone to the server at the emergency call center 102 such that the 911 dispatcher is informed of the location of the emergency caller and can dispatch emergency personal (e.g., first responders) to the location of the emergency caller.

However, in conventional emergency call systems, the 911 dispatcher does not automatically receive personal information from the emergency caller when the 911 call is received. Instead, the 911 dispatcher must obtain information from the emergency caller by asking questions. Similarly, the first responders also must obtain any relevant personal or medical information from the emergency caller when they arrive at the location of the emergency caller. Thus, first responders may need to devote at least a portion of their time, upon arriving at the location of the emergency caller, to obtaining relevant information about the emergency caller, which may increase the amount of time required to administer emergency services, such as first aid. Moreover, first responders may have little or no knowledge of the emergency caller prior to arriving at the location of the emergency caller.

### SUMMARY

The present invention recognizes that there is a need for an emergency dispatcher to automatically receive information about an emergency caller upon initiation of an emergency call, such as a 911 call, such that the dispatcher can provide the information to first responders prior to their arrival at the location of the emergency caller without having to verbally ascertain this information from the emergency caller.

Exemplary embodiments of the invention are directed to a system, apparatus, and method of automatically providing an emergency profile, and more particularly, to a system, apparatus, and method of automatically providing a user profile to an emergency call center.

For example, an illustrative embodiment is directed to a system for automatically providing a user profile to an emergency call center. The system includes a network having a user profile manager configured to manage communication between a telecommunications device and the emergency call center. The user profile manager is configured to automatically transmit the user profile to the emergency call center in response to a predetermined event.

In an exemplary embodiment, the predetermined event includes an initiation of an emergency call by the telecommunications device. In another exemplary embodiment the predetermined event includes a lack of stimulus from the telecommunications device for a predetermined amount of time.

In an exemplary embodiment, at least one of the telecommunications device and the user profile manager includes a user interface or web interface for creating the user profile.

In another exemplary embodiment, at least one of the telecommunications device and the user profile manager includes a memory that stores the user profile, a plurality of user profiles corresponding to the user of the telecommunications device, and/or a plurality of user profiles corresponding to a plurality of users of the telecommunications device. In yet another exemplary embodiment, the user profile manager includes a memory that stores a plurality of user profiles which correspond to a plurality of telecommunications devices. In another exemplary embodiment, the user profile is associated with a plurality of telecommunications devices.

In an exemplary embodiment, the network is configured to manage a voice communication and/or a data communication between the telecommunications device and the emergency call center. In another exemplary embodiment, the telecommunications device is configured to simultaneously perform voice communication and data communication.

In an exemplary embodiment, the telecommunications device is any device capable of voice communication and/or data communication.

In an exemplary embodiment, the telecommunications device includes a user profile application that detects the predetermined event. In response to the predetermined event, the user profile application is configured to automatically transmit a notification to the user profile manager. In another exemplary embodiment, the notification is transmitted by the user profile application to the user profile manager via one of a general packet radio service (GPRS), a cellular wide area network (WAN), and a short text messaging (SMS).

In an exemplary embodiment, the telecommunications device includes a global positioning system (GPS), and the telecommunications device is configured to automatically transmit a location of the telecommunications device based upon global positioning system (GPS) data to the user profile manager in response to the predetermined event. The user profile manager is configured to automatically transmit the location of the telecommunications device to the emergency call center upon receipt of the location from the telecommunications device.

In another exemplary embodiment, the network includes a wireless fidelity (Wi-Fi) network, and the telecommunications device is configured to automatically transmit a location of the telecommunications device based upon access point association to the user profile manager in response to the predetermined event. The user profile manager is configured to automatically transmit the location of the telecommunications device to the emergency call center upon receipt of the location from the telecommunications device.

In yet another exemplary embodiment, the network includes a Digital Enhanced Cordless Telecommunications (DECT) base station, and the telecommunications device is configured to automatically transmit a location of the telecommunications device based upon cluster identification (cluster ID) to the user profile manager in response to the predetermined event. The user profile manager is configured to automatically transmit the location of the telecommunications device to the emergency call center upon receipt of the location from the telecommunications device.

In an exemplary embodiment, the emergency call center includes a call coordinator which is configured to receive the user profile from the user profile manager and transmit the user profile to an emergency dispatcher.

In an exemplary embodiment, upon the initiation of the emergency call, the emergency profile continues to be transmitted when the emergency call is ended via intended or unintended device interaction. In another exemplary embodiment, upon the initiation of the emergency call, the emergency profile continues to be transmitted when the telecommunications device is powered down via intended or unintended device interaction.

In an exemplary embodiment, the user profile manager is configured to automatically transmit the user profile to one or more additional destinations in response to the predetermined event.

In another exemplary embodiment, the telecommunications device is one of a network telephone, a cellular telephone, an internet protocol telephone, an on-premise telephone, and a mobile device.

In another exemplary embodiment, the call coordinator includes a buffer for buffering the user profile until a voice connection is established between the telecommunications device and the emergency dispatcher.

An illustrative embodiment is directed to a telecommunications device for automatically providing a user profile to an emergency dispatcher of an emergency call center. The exemplary telecommunications device includes a user profile application that detects an initiation of an emergency call by the telecommunications device. In response to the initiation of the emergency call, the user profile application is configured to automatically transmit a notification to a user profile manager to trigger the transmission of the user profile to the emergency call center.

An illustrative embodiment is directed to a user profile manager for automatically providing a user profile to an emergency dispatcher of an emergency call center. The user profile manager is configured to manage communication between a telecommunications device and the emergency call center and to automatically transmit the user profile to the emergency call center in response to a predetermined event.

An illustrative embodiment is directed to a method of automatically providing a user profile, which includes information on a user of a telecommunications device, to an emergency dispatcher of an emergency call center. The exemplary method includes detecting a predetermined event, and automatically transmitting the user profile to the emergency call center in response to the predetermined event, thereby providing the emergency dispatcher with the information on the user of the telecommunications device.

In an exemplary embodiment, the step of detecting of the predetermined event includes detecting an initiation of an emergency call by the telecommunications device.

In an exemplary embodiment, the method further includes automatically transmitting a location of the telecommunications device to the emergency call center in response to the initiation of the emergency call. In another exemplary embodiment, the method further includes receiving the user profile at the emergency call center, and buffering and/or transmitting the user profile to the emergency dispatcher. In yet another exemplary embodiment, the method further includes transmitting the user profile from the emergency call center to a first responder.

In an exemplary embodiment, the method further includes creating the user profile using at least one of a user interface of the telecommunications device and a web interface. In another exemplary embodiment, the method further includes storing the user profile on the telecommunications device and/or storing the user profile in the user profile manager.

In an exemplary embodiment, the method further includes automatically transmitting a notification of the initiation of the emergency call from the telecommunications device to a user profile manager to trigger the automatically transmitting the user profile to the emergency call center, wherein the notification is automatically transmitted from the telecommunications device to the user profile manager via one of a general packet radio service (GPRS), a cellular wide area network (WAN), and a short text messaging (SMS).

In an exemplary embodiment, the step of detecting of the predetermined event including determining, by a network configured to manage communication between the telecommunications device and the emergency call center, that the telecommunications device is not detected for a predetermined amount of time.

In an exemplary embodiment, the step of detecting of the predetermined event includes determining, by a network configured to manage communication between the telecommunications device and the emergency call center, a lack of stimulus from the telecommunications device, and monitoring a duration of the lack of stimulus from the telecommunications device, wherein, when a predetermined amount of time has elapsed, the user profile is automatically transmitted to the emergency call center in response to the lack of stimulus from the telecommunications device, thereby providing the emergency call center with the information on the user of the telecommunications device.

In an exemplary embodiment, the method includes storing a plurality of user profiles corresponding to the user of the telecommunications device. Upon the detection of the predetermined event, the method further includes selecting the user profile from the plurality of user profiles based on one or more predetermined factors, and automatically transmitting the selected user profile to the emergency call center in response to the predetermined event, thereby providing the emergency call center with the information on the user of the telecommunications device.

In an exemplary embodiment, the method includes storing a plurality of user profiles corresponding to a plurality of users of the telecommunications device. Upon the detection of the predetermined event, the method includes identifying the user from the plurality of users and selecting the user profile, which corresponds to the user, from the plurality of user profiles based on one or more predetermined factors, and automatically transmitting the selected user profile to the emergency call center in response to the predetermined event, thereby providing the emergency call center with the information on the user of the telecommunications device.

In an exemplary embodiment, the method includes storing the user profile of the user, wherein the user profile is associated with a plurality of telecommunications devices. Upon the detection of the predetermined event, the method includes identifying the telecommunications device and selecting the user profile associated with the identified telecommunications device, and automatically transmitting the selected user profile to the emergency call center in response to the predetermined event, thereby providing the emergency call center with the information on the user of the identified telecommunications device.

In an exemplary embodiment, the user profile is automatically transmitted to one or more additional destinations in response to the predetermined event.

In an exemplary embodiment, the method includes storing correspondence data between the user and the telecommunications device when the user logs on to a physical location having the telecommunications device, wherein, when the predetermined event is detected, the user profile corresponding to the user that is logged in to the physical location having the telecommunications device is automatically transmitted to the emergency call center.

In an exemplary embodiment, a method of automatically providing a user profile, which includes information on a user of a first telecommunications device, to an emergency call center, is provided. The method can include associating the user profile of the user with the first telecommunications device, wherein the first telecommunications device is provided at a first physical location, and wherein the first telecommunications device is associated with a first private branch exchange (PBX), determining when the user logs in to a second telecommunications device, wherein the second telecommunications device is provided at a second physical location that is different from the first physical location, wherein the second telecommunications device is associated with the first private branch exchange (PBX) or a second private branch exchange (PBX), detecting a predetermined event at the second telecommunications device, and automatically transmitting the user profile which is associated with the first telecommunications device to the emergency call center in response to the predetermined event at the second telecommunications device, thereby providing the emergency call center with the information on the user of the first telecommunications device.

The exemplary embodiments of the present invention may provide better response from the first responders in that the first responders will have some knowledge of the emergency caller prior to arriving at the location of the emergency caller and administering emergency assistance, such as first aid. Accordingly, the first responders may be better prepared to administer emergency services, such as first aid, to the emergency caller when they arrive at the location of the emergency caller. This also may reduce the response time for administering emergency assistance in that the time devoted by the first responders to ascertaining relevant information from the emergency caller upon arrival at the location of the emergency caller can be reduced.

### BRIEF DESCRIPTION OF THE DRAWINGS

The accompanying drawings are presented to aid in the description of embodiments of the invention and are provided solely for illustration of the embodiments and not limitation thereof.

FIG. 1 depicts a schematic diagram of a conventional telecommunications system 100.

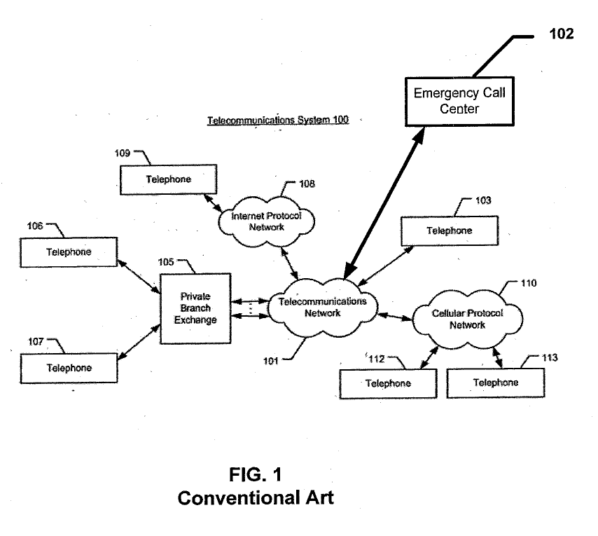

FIG. 2 depicts a schematic diagram of an automatic emergency profile system, in accordance with an illustrative embodiment of the present invention.

FIG. 3 depicts a flowchart of the operation of an automatic emergency profile method 300, in accordance with an illustrative embodiment of the present invention.

FIG. 4 depicts a flowchart of the operation of an automatic emergency profile method 400, in accordance with an illustrative embodiment of the present invention.

FIG. 5 depicts a schematic diagram of a telephone, in accordance with an illustrative embodiment of the present invention.

FIG. 6 depicts a flowchart of the operation of an automatic emergency profile method 600, in accordance with an illustrative embodiment of the present invention.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

The present invention relates to a system, apparatus, and method of automatically providing an emergency profile, and more particularly, to a system, apparatus, and method of automatically providing a user profile to, for example, an emergency dispatcher of an emergency call center.

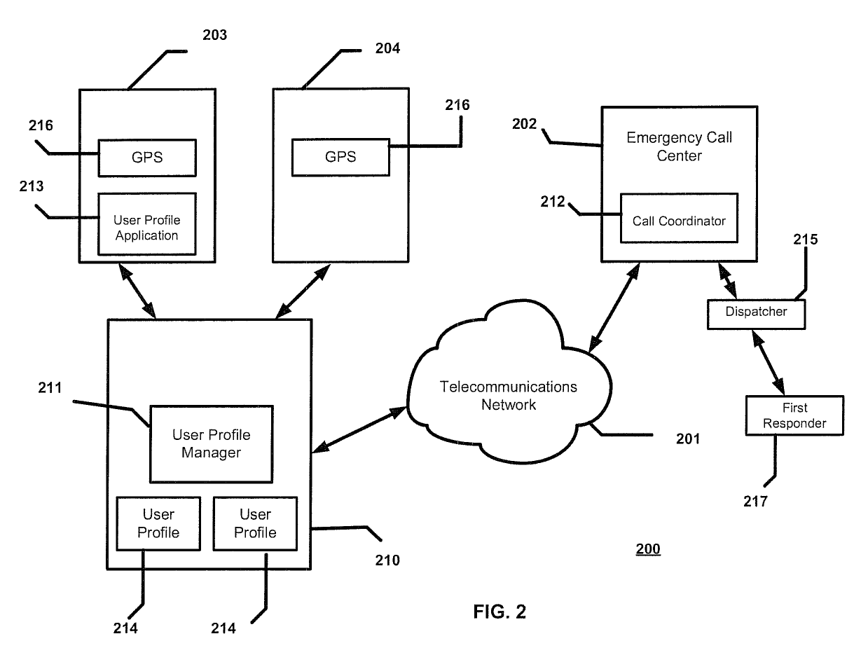

Exemplary embodiments of the invention will now be described with reference to FIGS. 2-6.

FIG. 2 illustrates a system 200 for automatically providing an emergency profile, according to an exemplary embodiment of the invention. The system 200 can include, for example, one or more telecommunications devices 203, 204, a network 210 including a user profile manager 211 and user profile 214, a telecommunications network 201, an emergency call center 202 including, for example, a call coordinator 212, a dispatcher 215, and a first responder 217.

According to the exemplary embodiments, the emergency call center 202 can be, for example, a 911 emergency call center, corporate headquarters, building security, campus security, a local security center, etc.

Accordingly, an embodiment can include, for example, a network 210 having a user profile manager 211 configured to manage communication between a telecommunications device 203, 204, and an emergency call center 202. According to the embodiment, the user profile manager 211 can be configured to automatically transmit a user profile 214 having information on the user of the telecommunications device 203, 204 to the emergency call center 202 in response to a predetermined event, such as an initiation of an emergency call by the telecommunications device 203, 204. As will be explained below, the predetermined event can include other events, such as the dialing of 911, the inputting or activating of an emergency or panic button, the telecommunications device not being detected by the network for a predetermined period of time, a lack of stimulus from the telecommunications device, etc.

Exemplary embodiments of the telecommunications device 203, 204, the user profile manager 211, and the call coordinator 212 and their respective operations will now be described.

With reference again to FIG. 2, the telecommunications device 203, 204 can be any device that is capable of voice communication and/or data communication. For example, the telecommunications device 203, 204 can be a wired or wireless telephone, a mobile device such as a personal data assistant (PDA), a voice over internet protocol (VoIP) telephone, an on-premise telephone, a computer capable of voice and/or data communication, such as a desktop computer or a portable/notebook computer, etc. One of ordinary skill in the art will recognize that other devices, such as devices that are capable of video communications, also are capable of voice communication, and thus, are telecommunications devices 203, 204 within the spirit and scope of the present invention.

According to an embodiment of the invention, the telecommunications device 203, 204 can simultaneously perform voice communication and data communication. That is, the telecommunications device can simultaneously send voice and data.

The telecommunications device, for example 203, according to an embodiment, can be configured to run a user profile application 213 for monitoring the input or dialing of a respective user (e.g., an owner or operator of the telephone 203) such that the user profile application 213 can detect a predetermined event, such as the initiation of an emergency call being performed by the user of the telecommunications device 203.

Accordingly, as shown for example in FIG. 2, an embodiment includes a telecommunications device 203 for automatically providing a user profile 214 to an emergency dispatcher 215 of an emergency call center 202. The exemplary telecommunications device 203 includes a user profile application 211 that detects a predetermined event, such as an initiation of an emergency call by the telecommunications device 203. In response to the predetermined event, the user profile application 213 is configured to automatically transmit a notification to the user profile manager 211 to trigger the transmission of the user profile 214 to the emergency call center.

In another embodiment of the invention, the telecommunications device, for example 204, can be any telecommunications device capable of initiating an emergency call. That is, according to the embodiments of the invention, it is not necessary for the telecommunications device 204 to include a user profile application. In operation, the telecommunications device 204 initiates the emergency call. As set forth in the embodiment described below, the user profile manager 211 of the network 210, which handles routing of an emergency call from the telecommunications device 204 to the call coordinator 212 of the emergency call center 202, can automatically transmit the user profile 214 to the emergency call center 202 in response to a predetermined event, such as the initiation of the emergency call by the telecommunications device 204, without receiving a separate notification from the telecommunications device 204.

In the exemplary embodiment illustrated in FIG. 2, the network 210 provides voice communication and/or data communication services to the telecommunications device 203 or 204. The network 210 provides access to the telecommunications network 201. In an embodiment, the network 210 can handle routing of an emergency call from the telecommunications device to the call coordinator 212 of the emergency call center 202. The network 210 can be, for example, a telephone service provider, a cellular telephone service provider, an Internet protocol provider, a private branch exchange (PBX), a wireless fidelity (Wi-Fi) network, a Digital Enhanced Cordless Telecommunications (DECT) base station, etc.

In the exemplary embodiment illustrated in FIG. 2, the user profile manager 211 operates on a server of the network 210 and manages communications between, for example, the telecommunications device 203 or 204 and the emergency call center 202. According to an exemplary embodiment, the user profile manager 211 can be configured to automatically transmit a user profile 214 having information on the user of the telecommunications device 203, 204 to the emergency call center 202 in response to a predetermined event, such as an initiation of an emergency call by the telecommunications device 203, 204.

Embodiments of the user profile manager 211 can manage communications for one or more telecommunications devices of a same type, as well as communications for a plurality of types of telecommunications devices, as described above.

In another embodiment, the user profile manager 211 is configured to automatically transmit the user profile 214 to one or more additional destinations in response to a predetermined event, such as the initiation of the emergency call by the telecommunications device 203, 204. That is, in addition to transmitting the user profile 214 to the emergency call center 202, the user profile manager 211 according to this embodiment is configured to automatically transmit the user profile 214 to one or more additional destinations, such as a 911 emergency call center, a local security center, corporate headquarters, building security, campus security, etc., in response to a predetermined event, such as the initiation of the emergency call by the telecommunications device 203, 204.

In an embodiment, a user profile 214 (e.g., emergency personal profile) can be created, for example, by entering data on the user's telecommunication device 203, 204, or by entering data using a graphic user interface via a web site. For example, the user profile 214 may include, but is not limited to, a digital picture of the user, vital statistics of the user, such as height, weight, hair color, eye color, blood type, etc. The ordinarily skilled artisan will recognize that other information, such as pre-existing medical conditions, allergies, prior medical history, etc. can be included in the user profile 214. Moreover, the information is not limited to physical or physiological information regarding the user, but may include, among other things, other information regarding the user, such as the user's residence, occupation, employer, birth date, emergency contact information, family information, etc.

The user profile 214 can be stored remotely from the telecommunications device, for example, by the user profile manager 211 of the network 210. One of ordinary skill in the art will recognize that one or more profiles 214, which correspond to one or more users and telecommunications devices 203, 204, can be stored by the user profile manager 211, as illustrated in FIG. 2.

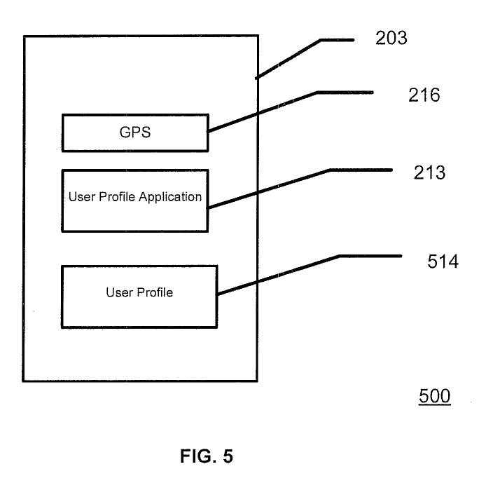

In another embodiment, as exemplarily illustrated in FIG. 5, each respective user profile 514 can be stored locally on the telecommunications device (e.g., 203). Accordingly, an embodiment can include a telecommunications device 203 for automatically providing a user profile 214 to an emergency dispatcher 215 of an emergency call center 202 in which the telecommunications device 203 has a memory for storing the user profile 214. In the exemplary embodiment, the telecommunications terminal 203 automatically transmits the user profile 214 to the user profile manager 211 of the network 210, which in turn, automatically transmits the user profile 214 to the emergency call center 202.

As set forth above, the user profile manager 211 of the server of the network 210 can store one or more user profiles 214. The user profile manager 211 also can provide a web interface for entering and storing the user's personal data in a user profile 214. The user profile manager 211 also can manage data and voice connections between the telecommunications device 203, 204 and the emergency call center 202.

Accordingly, as shown for example in FIG. 2, an embodiment includes a user profile manager 211 for automatically providing a user profile 214 to an emergency dispatcher 215 of an emergency call center 202. The user profile manager 211 is configured to manage communication between the telecommunications device 203, 204 and the emergency call center 202 and to automatically transmit the user profile 214 to the emergency call center 202 in response to the initiation of an emergency call by the telecommunications device 203, 204.

As set forth above with reference to FIG. 2, a call coordinator 212 operates on a server residing in the emergency call center 202. The call coordinator 212 can maintain a secure data link with the user profile manager 211 of the server of the network 210.

According to an embodiment of the invention, a user profile 214 (e.g., personal profile) can be created and stored by the user profile manager 211 running on a server of the network 210. The user profile 214 can be provided to the emergency dispatcher 215 automatically and simultaneously with the emergency call (e.g., a 911 call), thereby facilitating a more informed response to an emergency caller by the first responders 217. Accordingly, the embodiments of the invention can solve the problems of the conventional systems by automatically sending a user profile 214 having previously stored personal information on the emergency caller to the emergency dispatcher 215 when an emergency call is initiated or launched from the emergency caller's telecommunications device 203, 204.

In another embodiment, one or more of the telecommunications devices (e.g., 203, 204) can include a global positioning system (GPS) 216 for determining a location of the telecommunications device, for example, as illustrated in FIG. 2. According to an exemplary embodiment, the telecommunications device is configured to automatically transmit a location of the telecommunications device based upon global positioning system (GPS) data to the user profile manager 211 in response to a predetermined event, such as the initiation of the emergency call. The user profile manager 211 is configured to automatically transmit the location of the telecommunications device to the emergency call center 202 upon receipt of the location from the telecommunications device.

In another exemplary embodiment, the network 210 includes a wireless fidelity (Wi-Fi) network and the telecommunications device is configured to automatically transmit a location of the telecommunications device based upon access point association to the user profile manager 211 in response to a predetermined event, such as the initiation of the emergency call. The user profile manager 211 is configured to automatically transmit the location of the telecommunications device to the emergency call center 202 upon receipt of the location from the telecommunications device.

In another exemplary embodiment, the network 210 includes a Digital Enhanced Cordless Telecommunications (DECT) base station, and the telecommunications device is configured to automatically transmit a location of the telecommunications device based upon cluster identification (cluster ID) to the user profile manager 211 in response to a predetermined event, such as the initiation of the emergency call. The user profile manager 211 is configured to automatically transmit the location of the telecommunications device to the emergency call center 202 upon receipt of the location from the telecommunications device.

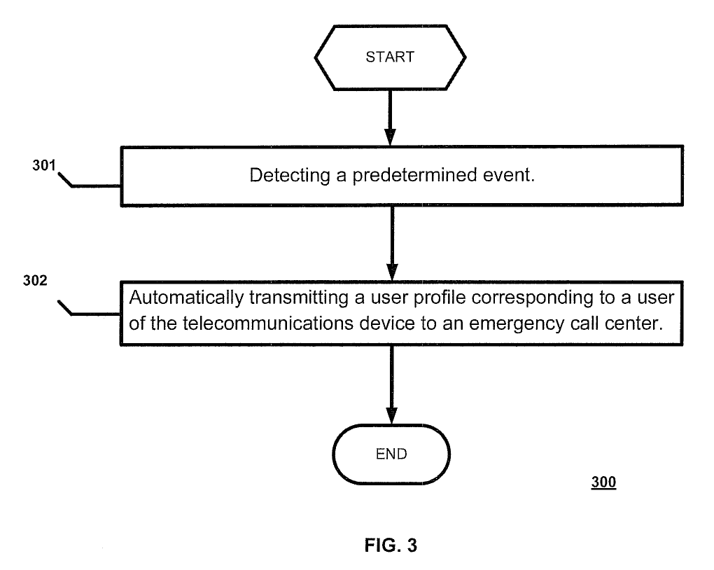

For example, FIG. 3 illustrates an exemplary method 300 of automatically providing a user profile 214, which includes information on a user of a telecommunications device 203, 204, to an emergency dispatcher 215 of an emergency call center 202, according to an embodiment of the invention. The exemplary method includes detecting a predetermined event, such as an initiation of an emergency call by a telecommunications device (e.g., step 301), and automatically transmitting a user profile corresponding to a user of the telecommunications device to an emergency call center in response to the predetermined event, such as the initiation of the emergency call (e.g., step 302), thereby providing the emergency dispatcher with information on the user of the telecommunications device.

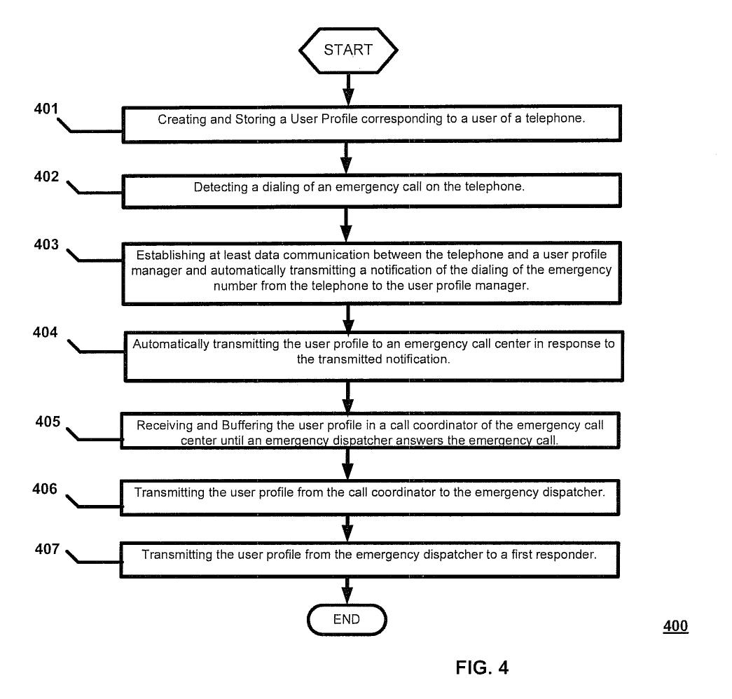

Another exemplary method 400 according to an embodiment of the invention will now be described with reference to FIG. 4.

The exemplary method 400 includes a step of creating and storing a user profile corresponding to a user of a telecommunications device (e.g., step 401). The method further includes detecting a predetermined event, such as an initiation (e.g., dialing) of an emergency call by the telecommunications device (e.g., step 402), establishing communication (e.g., at least a data communication) between the telecommunications device and a user profile manager, and automatically transmitting a notification of the initiation of the emergency number from the telecommunications device to the user profile manager (e.g., step 403).

The user profile is then automatically transmitted to an emergency call center in response to the transmitted notification (e.g., step 404). The user profile is received and buffered in a call coordinator of the emergency call center until an emergency dispatcher answers the emergency call (e.g., step 405). When the emergency dispatcher answers the emergency call, the user profile is transmitted from the call coordinator to the emergency dispatcher (e.g., step 406). The emergency dispatcher then transmits the user profile to a first responder (e.g., step 407). In another embodiment, the user profile is transmitted from the call coordinator directly to the first responder.

Accordingly, the embodiments of the invention can improve the preparedness and efficiency of the first responders due to the first responders' knowledge of the patient prior to administering emergency services, such as first aid.

As exemplarily illustrated by the embodiments of FIGS. 2-6, a user profile manager 211 of a network 210 can be configured to detect a predetermined event, such as an initiation of an emergency call (e.g., the dialing of an emergency number, such as 911) by a user of a telecommunications device 203, 204. When the user of a telecommunications device 203, 204 initiates an emergency call, for example, by dialing a local emergency number such as 911, the user profile manager 213 of the telephone detects that an emergency call is being placed. The telecommunications device (e.g., 203, 204, etc.) establishes communication with a server of the network 210 and a call is launched to an appropriate emergency call center 202.

The communication between the telecommunications device 203, 204 and the server of the network 210 can be, for example, via General Packet Radio Service (GPRS), cellular wide area network (WAN), short text messaging (SMS), etc., or other standards that can support a wide range of bandwidths, provide an efficient use of limited bandwidth, and/or are particularly suited for sending and receiving small bursts of data, such as e-mail and Web browsing, and/or large volumes of data.

Upon establishing communication with the server of the network 210, the user profile application 213 of the telecommunications device 203, 204 automatically sends data (e.g., a notification) to the user profile manager 211 operating on a server of the network 210 to notify the user profile manager 211 that an emergency call is being initiated or launched. Upon receiving the notification from the user profile application 213 of the telecommunications device 203, 204, the user profile manager 211 of the network 210 transmits the user profile information 214 to a call coordinator 212 operating on a server of an appropriate emergency call center 202.

The call coordinator 212 of the emergency call center 202 can be configured to maintain a secure data link with the user profile manager 211 of the network 210. The user profile manager 211 is triggered, for example, upon a predetermined event, such as the initiation of the emergency call by the telecommunications device (e.g., 204) or upon receipt of the notification from the telecommunications device (e.g., 203), to automatically transmit the user profile 214 to the call coordinator 212 of the emergency call center 202. Upon receipt of the user profile information 214, the call coordinator 212 buffers the user profile information 214 until the emergency call is answered by an agent or dispatcher 215 at the emergency call center 212. The user profile information 214 is then transmitted to the dispatcher's terminal or personal computer (PC). The emergency dispatcher 215 then alerts the appropriate first aid team (e.g., first responders 217) and provides this team the user profile information 214 of the emergency caller. Accordingly, the embodiments of the invention can improve the preparedness and efficiency of the first responders 217 due to the first responders' knowledge of the patient prior to administering emergency services, such as first aid.

As mentioned above, in an embodiment of the invention, the user profile information 214 can be stored remotely, for example, by a user profile manager 211 operating on a server of the network 210. The embodiment provides an important advantage in that, upon the initiation of the emergency call by the telecommunications device (e.g., 204) to the network 210, or the transmission of a minimal amount of data needed from the telecommunications device (e.g., 203) to the user profile manager 211 of the network 210, to notify the user profile manager 211 of the emergency call, the user profile manager 211 of the network 210 will transmit the user profile 214 to the emergency call center 212 irrespective of whether the emergency call is continued.

For example, in an exemplary embodiment, upon the initiation of the emergency call, the emergency profile 214 continues to transmit to the emergency call center 202 when the emergency call is ended via intended or unintended interaction with the telecommunications device. In another exemplary embodiment, upon the initiation of the emergency call, the emergency profile 214 continues to be transmitted to the emergency call center 202 when the telecommunications device is powered down via intended or unintended interaction with the telecommunications device.

Accordingly, if the voice communication or data communication of the emergency call is ended, for example, unintentionally or due to the incapacitation of the emergency caller, prior to the completion of the emergency call to the emergency call center 202, the user profile manager 211 of the network 210 will continue to transmit the user profile 214 to the emergency call center 202 without user intervention so long as the emergency call has been initiated by the telecommunications device (e.g., 204) or the notification has been received from the telecommunications device (e.g., 203).

In this way, embodiments of the present invention provide an important advantage in that only a minimal amount of data (e.g., the initiation of the emergency call or the notification) needs to be transmitted from the telecommunications device to the user profile manager 211 of the network 210 to trigger the transmission of the user profile 214 from the user profile manager 211 to the emergency call center 202. Thus, the emergency dispatcher 215 can obtain important or critical information about the emergency caller from the user profile 214 and forward such information to the first responders 217 while they are in route to the location of the user (e.g., prior to their arrival at the location of the user). Accordingly, the embodiments of the invention can improve the preparedness and efficiency of the first responders due to the first responders' knowledge of the patient prior to administering emergency services, such as first aid.

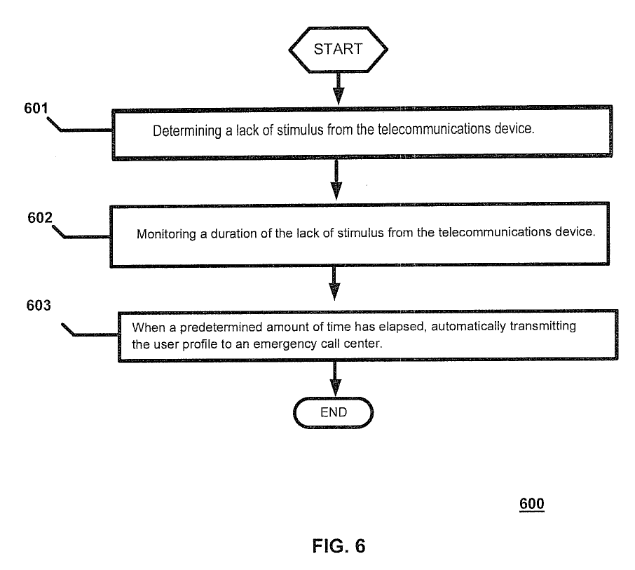

Other exemplary methods according to embodiments of the invention will now be described with reference to FIG. 6. For example, in one exemplary embodiment, the method can include detecting the predetermined event by determining, by a network configured to manage communication between the telecommunications device and the emergency call center, that the telecommunications device is not detected for a predetermined amount of time. For example, in an embodiment, the telecommunications device may not be detected by the network for a predetermined amount of time. When this time has elapsed, the profile manager can automatically transmit the user profile to the emergency call center in response to the lack of stimulus from the telecommunications device, thereby providing the emergency dispatcher with the information on the user of the telecommunications device.

With reference to FIG. 6, an exemplary method 600 includes a step of detecting the predetermined event by determining, for example by a network configured to manage communication between the telecommunications device and the emergency call center, a lack of stimulus from the telecommunications device (e.g., step 601), and monitoring a duration of the lack of stimulus from the telecommunications device (e.g., step 602). When a predetermined amount of time has elapsed, the user profile can be automatically transmitted to the emergency call center in response to the lack of stimulus from the telecommunications device (e.g., step 603), thereby providing the emergency call center with the information on the user of the telecommunications device.

In another embodiment, the telecommunications device can contain multiple profiles where the profile sent to the emergency call center is chosen by one or more factors, such as the date, the time of day (e.g., shift work), the input of an additional code, biometrics, etc. Accordingly, the telecommunications device can automatically transmit the corresponding user profile to the emergency call center in response to the predetermined event, thereby providing the emergency dispatcher with the information on the user of the telecommunications device.

For example, an exemplary method can include storing a plurality of user profiles corresponding to the user of the telecommunications device. Upon the detection of the predetermined event, the method can include selecting the user profile from the plurality of user profiles based on one or more predetermined factors, and automatically transmitting the selected user profile to the emergency call center in response to the predetermined event, thereby providing the emergency call center with the information on the user of the telecommunications device.

In another embodiment, the telecommunications device can have multiple users. According to the embodiment, the profile sent to the emergency call center is selected based on one or more factors, such as the date, time of day (e.g., shift work), the input of an additional code, biometrics, etc. Accordingly, the profile manager can automatically transmit the corresponding user profile to the emergency call center in response to the initiation of the emergency call, thereby providing the emergency dispatcher with the information on the user of the telecommunications device.

For example, an embodiment can include storing a plurality of user profiles corresponding to a plurality of users of the telecommunications device. Upon the detection of the predetermined event, the method can include identifying the user from the plurality of users and selecting the user profile, which corresponds to the user, from the plurality of user profiles based on one or more predetermined factors, and automatically transmitting the selected user profile to the emergency call center in response to the predetermined event, thereby providing the emergency call center with the information on the user of the telecommunications device.

In an embodiment, the telecommunication device can be one of multiple devices associated with an individual user. For example, an embodiment can include storing the user profile of the user, wherein the user profile is associated with a plurality of telecommunications devices. Upon the detection of the predetermined event, the method can include identifying the telecommunications device and selecting the user profile associated with the identified telecommunications device, and automatically transmitting the selected user profile to the emergency call center in response to the predetermined event, thereby providing the emergency call center with the information on the user of the identified telecommunications device.

According to another embodiment, the method can include storing correspondence data between the user and the telecommunications device when the user logs on to a physical location having the telecommunications device, wherein, when the predetermined event is detected, the user profile corresponding to the user that is logged in to the physical location having the telecommunications device is automatically transmitted to the emergency call center.

For example, in an embodiment, the user may be stationed at location A (e.g., a first location) at which the user typically uses telecommunications device A (e.g., a first telecommunications device), which is associated with private branch exchange (PBX) A (e.g., first PBX). A user may move to a physical location B (e.g., a second location) and log in at telecommunications device B (e.g., the second telecommunications device), which is associated with either the same private branch exchange (PBX) A (e.g., first PBX), or a different private branch exchange (PBX) B (e.g., second PBX). A Q Signaling (i.e., Q (point of the ISDN model) Signaling or QSIG) trunk can connect PBX A (e.g., first PBX) and PBX B (e.g., second PBX). When the user logs in at telecommunications device B (e.g., the second telecommunications device), the user's button associations and extension from PBX A (e.g., first PBX) can be transferred to device B (e.g., the second telecommunications device).

According to an embodiment of the invention, the method can determine when the user logs in at telecommunications device B (e.g., the second telecommunications device), and when the user initiates an emergency call on device B (e.g., the second telecommunications device), the profile manager can send the correct emergency profile associated with user A coordinated with the users current physical location, which in the example is physical location B (e.g., a second location).

In another exemplary embodiment, a method of automatically providing a user profile, which includes information on a user of a first telecommunications device, to an emergency call center, is provided. The method can include associating the user profile of the user with the first telecommunications device, wherein the first telecommunications device is provided at a first physical location, and wherein the first telecommunications device is associated with a first private branch exchange (PBX), determining when the user logs in to a second telecommunications device, wherein the second telecommunications device is provided at a second physical location that is different from the first physical location, wherein the second telecommunications device is associated with the first private branch exchange (PBX) or a second private branch exchange (PBX), detecting a predetermined event at the second telecommunications device, and automatically transmitting the user profile which is associated with the first telecommunications device to the emergency call center in response to the predetermined event at the second telecommunications device, thereby providing the emergency call center with the information on the user of the first telecommunications device.

In another example, the method can include storing correspondence data between the user and a first telecommunications device when the user logs in to a first physical location having the first telecommunications device associated with a first private branch exchange (PBX). The method further can include storing correspondence data between the user and a second telecommunications device when the user logs in to a second physical location having the second telecommunications device associated with a second private branch exchange (PBX). When the predetermined event is detected, the user profile corresponding to the user that is logged in to the second physical location having the second telecommunications device is automatically transmitted to the emergency call center.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an embodiment of the invention can include a computer readable media embodying a method of automatically providing a user profile, which corresponds to a user of a telephone, to an emergency dispatcher of an emergency call center. Accordingly, the invention is not limited to illustrated examples and any means for performing the functionality described herein are included in embodiments of the invention.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A system for automatically providing a user profile to an emergency call center, the system comprising:
a network having a user profile manager configured to manage communication between a telecommunications device and the emergency call center;
wherein the user profile manager is configured to automatically transmit the user profile to the emergency call center in response to a predetermined event.

2. The system according to claim 1, wherein the predetermined event comprises:
an initiation of an emergency call by the telecommunications device.

3. The system according to claim 1, wherein the predetermined event comprises:
a lack of stimulus from the telecommunications device for a predetermined amount of time.

4. The system according to claim 1, wherein at least one of the telecommunications device and the user profile manager comprises a user interface or web interface for creating the user profile.

5. The system according to claim 1, wherein at least one of the telecommunications device and the user profile manager comprises:
a memory that stores the user profile, a plurality of user profiles corresponding to the user of the telecommunications device, and/or a plurality of user profiles corresponding to a plurality of users of the telecommunications device.

6. The system according to claim 1, wherein the user profile manager comprises:
a memory that stores a plurality of user profiles which correspond to a plurality of telecommunications devices.

7. The system according to claim 1, wherein the user profile is associated with a plurality of telecommunications devices.

8. The system according to claim 1, wherein the network is configured to manage a voice communication and/or a data communication between the telecommunications device and the emergency call center.

9. The system according to claim 1, wherein the telecommunications device is configured to simultaneously perform voice communication and data communication.

10. The system according to claim 1, wherein the telecommunications device is any device capable of voice communication and/or data communication.

11. The system according to claim 1, wherein the telecommunications device includes a user profile application that detects the predetermined event; and
wherein, in response to the predetermined event, the user profile application is configured to automatically transmit a notification to the user profile manager.

12. The system according to claim 11, wherein the notification is transmitted by the user profile application to the user profile manager via one of a general packet radio service (GPRS), a cellular wide area network (WAN), and a short text messaging (SMS).

13. The system according to claim 1, wherein the telecommunications device includes a global positioning system (GPS),
wherein the telecommunications device is configured to automatically transmit a location of the telecommunications device based upon global positioning system (GPS) data to the user profile manager in response to the predetermined event, and
wherein the user profile manager is configured to automatically transmit the location of the telecommunications device to the emergency call center upon receipt of the location from the telecommunications device.

14. The system according to claim 1, wherein the network includes a wireless fidelity (Wi-Fi) network,
wherein the telecommunications device is configured to automatically transmit a location of the telecommunications device based upon access point association to the user profile manager in response to the predetermined event, and
wherein the user profile manager is configured to automatically transmit the location of the telecommunications device to the emergency call center upon receipt of the location from the telecommunications device.

15. The system according to claim 1, wherein the network includes a Digital Enhanced Cordless Telecommunications (DECT) base station,
wherein the telecommunications device is configured to automatically transmit a location of the telecommunications device based upon cluster identification (cluster ID) to the user profile manager in response to the predetermined event, and
wherein the user profile manager is configured to automatically transmit the location of the telecommunications device to the emergency call center upon receipt of the location from the telecommunications device.

16. The system according to claim 1, wherein the emergency call center includes a call coordinator which is configured to receive the user profile from the user profile manager and transmit the user profile to an emergency dispatcher.

17. The system according to claim 1, wherein, upon occurrence of the predetermined event, the emergency profile continues to be transmitted when the emergency call is ended via intended or unintended telecommunications device interaction.

18. The system according to claim 1, wherein, upon occurrence of the predetermined event, the emergency profile continues to be transmitted when the telecommunications device is powered down via intended or unintended telecommunications device interaction.

19. The system according to claim 1, wherein the user profile manager is configured to automatically transmit the user profile to one or more additional destinations in response to the predetermined event.

20. A telecommunications device for automatically providing a user profile to an emergency call center, the telecommunications device comprising:
a user profile application that detects an initiation of an emergency call by a user of the telecommunications device,
wherein, in response to the initiation of the emergency call, the user profile application is configured to automatically transmit a notification to a user profile manager to trigger the transmission of the user profile to the emergency call center.

21. A user profile manager for automatically providing a user profile to an emergency call center,
wherein the user profile manager is configured to manage communication between a telecommunications device and the emergency call center, and
wherein the user profile manager is configured to automatically transmit the user profile to the emergency call center in response to a predetermined event.

22. The system according to claim 21, wherein the predetermined event comprises:
an initiation of an emergency call by the telecommunications device.

23. A method of automatically providing a user profile, which includes information on a user of a telecommunications device, to an emergency call center, the method comprising:
detecting a predetermined event; and
automatically transmitting a user profile to the emergency call center in response to the predetermined event, thereby providing the emergency call center with the information on the user of the telecommunications device.

24. The method according to claim 23, wherein the detecting of the predetermined event comprises:
an initiation of an emergency call by the telecommunications device.

25. The method according to claim 23, further comprising:
automatically transmitting a location of the telecommunications device to the emergency call center in response to the predetermined event.

26. The method according to claim 23, further comprising:
receiving the user profile at the emergency call center; and
buffering and/or transmitting the user profile to the emergency call center.

27. The method according to claim 26, further comprising:
transmitting the user profile from the emergency call center to a first responder.

28. The method according to claim 23, further comprising:
creating the user profile using at least one of a user interface of the telecommunications device and a web interface.

29. The method according to claim 23, further comprising:
storing the user profile on the telecommunications device and/or storing the user profile in the user profile manager.

30. The method according to claim 23, further comprising:
automatically transmitting a notification of the predetermined event from the telecommunications device to a user profile manager to trigger the automatically transmitting the user profile to the emergency call center,
wherein the notification is automatically transmitted from the telecommunications device to the user profile manager via one of a general packet radio service (GPRS), a cellular wide area network (WAN), and a short text messaging (SMS).

31. The method according to claim 23, wherein the detecting of the predetermined event comprises:
determining, by a network configured to manage communication between the telecommunications device and the emergency call center, that the telecommunications device is not detected for a predetermined amount of time.

32. The method according to claim 23, wherein the detecting of the predetermined event comprises:
determining, by a network configured to manage communication between the telecommunications device and the emergency call center, a lack of stimulus from the telecommunications device; and
monitoring a duration of the lack of stimulus from the telecommunications device,
wherein, when a predetermined amount of time has elapsed, the user profile is automatically transmitted to the emergency call center in response to the lack of stimulus from the telecommunications device, thereby providing the emergency call center with the information on the user of the telecommunications device.

33. The method according to claim 23, further comprising:
storing a plurality of user profiles corresponding to the user of the telecommunications device;
upon the detection of the predetermined event, selecting the user profile from the plurality of user profiles based on one or more predetermined factors; and
automatically transmitting the selected user profile to the emergency call center in response to the predetermined event, thereby providing the emergency call center with the information on the user of the telecommunications device.

34. The method according to claim 23, further comprising:
storing a plurality of user profiles corresponding to a plurality of users of the telecommunications device;
upon the detection of the predetermined event, identifying the user from the plurality of users and selecting the user profile, which corresponds to the user, from the plurality of user profiles based on one or more predetermined factors; and
automatically transmitting the selected user profile to the emergency call center in response to the predetermined event, thereby providing the emergency call center with the information on the user of the telecommunications device.

35. The method according to claim 23, further comprising:
storing the user profile of the user, wherein the user profile is associated with a plurality of telecommunications devices;
upon the detection of the predetermined event, identifying the telecommunications device and selecting the user profile associated with the identified telecommunications device; and
automatically transmitting the selected user profile to the emergency call center in response to the predetermined event, thereby providing the emergency call center with the information on the user of the identified telecommunications device.

36. The method according to claim 23, wherein the user profile is automatically transmitted to one or more additional destinations in response to the predetermined event.

37. The method according to claim 23, further comprising:
storing correspondence data between the user and the telecommunications device when the user logs on to a physical location having the telecommunications device,
wherein, when the predetermined event is detected, the user profile corresponding to the user that is logged in to the physical location having the telecommunications device is automatically transmitted to the emergency call center.

38. A method of automatically providing a user profile, which includes information on a user of a first telecommunications device, to an emergency call center, the method comprising:
associating the user profile with the first telecommunications device, wherein the first telecommunications device is provided at a first physical location, and wherein the first telecommunications device is associated with a first private branch exchange (PBX);
determining when the user logs in to a second telecommunications device, wherein the second telecommunications device is provided at a second physical location that is different from the first physical location, wherein the second telecommunications device is associated with the first private branch exchange (PBX) or a second private branch exchange (PBX);
detecting a predetermined event at the second telecommunications device; and
automatically transmitting the user profile which is associated with the first telecommunications device to the emergency call center in response to the predetermined event at the second telecommunications device, thereby providing the emergency call center with the information on the user of the first telecommunications device.
